(19) United States
(12) Patent Application Publication
(10) Pub. No.: US 2006/0201438 A1
(43) Pub. Date: Sep. 14, 2006

(54) Clumping, non-dusting calcium carbonate-based animal litter

(76) Inventors: Arthur L. Anttila, Wilmington, DE (US); Christopher James Boyce, Aliso Viejo, CA (US); Daniel Lee Schiefelbein, Coto De Caza, CA (US)

Correspondence Address: Hercules Incorporated;Hercules Plaza, 1313 N. Market Street, Wilmington, DE, 19894-0001, US

(21) Appl. No.: 11/371,151

(22) Filed: Mar. 7, 2006

Related U.S. Application Data
(60) Provisional application No. 60/659,670, filed on Mar. 8, 2005.

(51) Int. Cl. A01K 29/00

(52) U.S. Cl. 119/171

(57) ABSTRACT

A particulate, free flowing but clumpable animal litter composition is composed of discrete, non-swelling, non-absorptive, calcium carbonate particles, and a fluid retention and clumping agent of at least one water-soluble polysaccharide. A non-toxic, biodegradable mineral oil can be used to partially coat the calcium carbonate particles.

This application claims the benefit of U.S. Provisional Application No. 60/659,670, filed Mar. 8, 2005.

### FIELD OF INVENTON

This invention is related to disposable animal litter and a method of making the same. More specifically, this invention is directed to an animal litter composition formed primarily from calcium carbonate in particulate form and a method of making the same.

### BACKGROUND OF THE INVENTION

Many species of animals and birds are raised and/or kept by people for various purposes for the production of valuable products such as for food, furs, experimental purposes, or for pets. A major problem connected with the raising and/or keeping of animals is the disposition of their waste excretions, mainly urine and feces. Whether the animal or bird is caged, in which case its waste is deposited on the floor of the cage, or allowed to roam free but is trained to deposit its waste in a particular receptacle, a “litter” material is generally used which is capable of absorbing the liquid portion of waste excretions, primarily urine and the excess liquid of fecal matter.

Animal and pet litters, such as cat litters, are typically mixtures of absorbent materials, odor controlling agents, clumping agents, and other functional or cosmetic enhancing additives. Absorbent materials cover a wide range of materials and can include recycled newsprint, paper sludge, corn cob granules, rice hulls, peanut hulls, alfalfa, cedar sawdust, and various clays such as calcium and sodium montmorillonites (including sodium bentonite), attapulgites, kaolins, and opal clay mixtures. Currently, clay-based litters which provide a clumping property allowing removal of liquid waste from the litter container without excessively contaminating the remaining litter have become popular and are now widely used.

While clay-based litters are widely used in litters with or without additives to deliver certain performance properties, they have a number of shortcomings. For example, the absorbent, swelling clay is compounded by a tacky surface texture which often accompanies the swelling of the clay. Further, because the swelling clay is an inorganic material that is not subject to biodegradation, a deposit of the swelling clay once lodged in building plumbing will tend to persist and accumulate more deposits. Over a period of time, household plumbing system in which they are lodged may become blocked. The clay will also become attached to the animal's fur or paws and will be tracked throughout the house. The dry clay in the house may become a source of dust that may carry microorganisms and/or cause allergic reactions. Also, when the animal licks its paws, the clay will be ingested by the animal and may cause the animal health problems.

Many approaches have been tried to produce a litter that is humane and animal safe and acceptable. U.S. Pat. No. 5,359,961 discloses a particulate, free-flowing but clumpable animal litter composition using non-swelling, absorbent clay particles having guar gum and carrageenan gum carried on the surface of the clay particles.

US Patent Application Publication No. US 2003/00/0072733 A1 discloses a free flowing, fragranced, moisture absorbing, composition of an enrobement material such as clays, silicas, celites, zeolites, metal salts, celluloses, starches, carbonates, borates, sulfates, water soluble polymers, borax, and mixtures thereof, a fragrance, an absorbent material, and a fixative.

U.S. Pat. No. 5,421,291 discloses an animal litter composition of a particulate water-absorbent, clayey component, a water-soluble salt of carboxymethylcellulose and a solid particulate deodorizing additive component of sodium bicarbonate or potassium bicarbonate, and mineral oil.

U.S. Pat. No. 6,053,125 discloses biodegradable, clumpable animal litter made from corncob and other biomass components. U.S. Pat. No. 5,101,771 discloses an animal litter of particulate, free flowing but clumpable discrete non-swelling clay particles having a water-soluble organic resin clumping agent dispersed in an oleaginous liquid vehicle on the surface of the clay particles.

None of the above mentioned prior art discloses the instant invention.

Hence, it is desirable to develop non-clay based alternatives from essentially non-absorbent materials, such as coarsely ground calcium carbonate, that can match the performances of existing clay-based products but provide additional benefits because of their silica free chemistry, natural odor fighting properties, non-dusting property, and prevention of the ability of clay to be ingested by the animal using the litter.

### SUMMARY OF THE INVENTION

The present invention is directed to a particulate, free flowing but clumpable animal litter composition of discrete non-swelling calcium carbonate particles and a fluid retention and clumping agent. The particles can optionally be coated with a nontoxic, biodegradable mineral oil. Various light-weight fillers, such as pelletized corn cob biomass, rice hulls, peanut hulls, alfalfa, and cedar sawdust can be used in minor amounts, e.g. 10-20%, to adjust the bulking value or final density of the mixture in order to accommodate packaging needs, etc.

The present invention is also related to a method for the preparation of free flowing particulate animal litter composition that clumps upon contact with an aqueous liquid by making a suspension of a water-soluble rheology modifier and mineral oil and distributing the suspension substantially uniformly over particulate, non-swelling, non-absorptive, calcium carbonate particles or by initially spraying a fine mist of mineral oil onto the surface of the calcium carbonate particles to partially coat the particles and then mixing the required quantity of fluid retention/clumping agent with the partially coated calcium carbonate particles.

### DETAILED DESCRIPTION OF THE INVENTION

It has been surprisingly found that calcium carbonate particles mixed with a water-soluble polysaccharide can be used to create a particulate free-flowing but clumpable animal litter composition that has redeeming characteristics for the owner, animal, and environment.

In accordance with the present invention, various polysaccharides can be used as the water retention and clumping agent. Examples of the polysaccharides that can be used as the the primary water retention and clumping agent are methylcellulose (MC), methylhydroxyethylcellulose (MHEC), methylhydroxypropylcellulose (MHPC), guar gum, guar gum derivatives (such as hydroxypropyl guar and hydroxyethyl guar) and combinations thereof. Other water-soluble polymers (WSPs), such as carboxymethylcellulose (CMC), hydroxyethylcellulose (HEC), ethylhydroxyethylcellulose (EHEC), hydroxypropylcellulose (HPC), carrageenan, xanthan gum, alginate, and various combinations thereof can be used as secondary water-retention and clumping agents. In other words, these secondary WSPs have to be used in combination with at least one of the primary water-retention and clumping agents. The polysaccharide has to be finely ground particle sizes in order to provide the desired performances and/or benefits in animal litters based on non-absorbent materials, such as coarse calcium carbonate. The clumping agent can be incorporated into the litter in the presence of a light mineral oil.

The viscosity ranges of the polysaccharides used as the clumping agent (e.g., MC and its derivatives, MHEC and MHPC) for use in this invention are 3,000 to 100,000 cps and higher as measured in an aqueous solution at 2% and 20° C. on a moisture-free basis on a Brookfield RV model viscometer at 20 rpm, using the appropriate spindle per the following table as chosen for the expected viscosity:

| Spindle size | Expected viscosity | |
|---|---|---|
| 4 | 3,000-8,499 | cps |
| 5 | 8,500-14,999 | cps |
| 6 | 15,000-50,000 | cps |
| 7 | >50,000, | cps |

Preferred particle size distributions of the polysaccharide clumping agent (such as MC, MC derivatives, guar and guar derivatives) should be the finer particle size types, such as those which would have an approximate maximum of 4% remaining on a 0.125 mm screen and an approximate minimum of 50% going through a 0.063 mm screen. Preferred viscosities of guar gum and guar derivatives, such as hydroxypropyl guar, are approximately 2,000 to 6,000 cps as measured in an aqueous solution at 1% and 25° C. on an “as-is” moisture basis and on a Brookfield RVT model viscometer at 20 rpm.

In accordance with the present invention, methylcellulose is an effective clumping agent in animal litters based on calcium carbonate. A clumping agent of methylcellulose in combination with MHEC and/or guar is a preferred and optimum blend of WSPs to form clumps of the desired proportions and green and dry strength which enables efficient use of litter material. MC and other WSPs when used in conjunction with mineral oil has many redeeming properties. This combination can eliminate the hazards potentially caused to pets or pet owners by the use of litters which contain respirable-silica containing fillers. An example of the potential hazards is the respiratory disease “silicosis”. Also, “respirable silica” which can be sourced from clay, has been recommended to be listed as a potential occupational carcinogen in testimony by the National Institute for Occupational Safety and Health (NIOSH) to the Occupational Safety and Health Administration (OSHA). The International Agency for Research on Cancer (IARC) as well has recommended that respirable silica be placed on the list of suspected human caricinogens. This combination also can act to eliminate health hazards to animals that are understood to be derived from some fine particle size mineral fillers lining the digestive tract of the animal using the litter. Animal litter of the present invention prepared from combinations of polysaccharides such as methylcellulose, methylcellulose derivatives, guar gum, other WSPs, and optimized combinations thereof especially when incorporated with the use of light mineral or other similar oils provide cost-effective and functional advantages in calcium carbonate-based, clumping pet litters over animal litters made from various clays and other absorbent materials. Some of the advantages of using the animal litter of the present invention are that the bright whiter color of calcium carbonate has a very clean appearance and makes it extremely easy to detect when the litter has been used by the animal. Another advantage of the animal litter of the present invention is that the use of larger particle sizes of calcium carbonate litter reduces the tendency for the animal to track the litter on the animal's paws in the house or containment areas. Also, calcium carbonate has a natural odor-fighting ability because of its chemistry so that there is reduced need for adding fragrances or perfumes to the animal litter.

In accordance with this invention, any white mineral oil can be used as long as it is in compliance with food contact regulations (i.e., it is edible). Hence, it is essential that it is non-toxic; the white mineral oil must also be biodegradable 60% at least after 28 days in freshwater and seawater under the Organization for Economical Commercial Development (OECD) 301 and OECD 306 protocols, respectively. Also, the white mineral oil should be in compliance with major Pharmacopoeia and F.D.A. regulations and the EPA requirements with regard to “oil and grease” test. It also should have a Classification in, at least, category “D” under revised OCNS regulations.

The white mineral oil should have a low kinetic viscosity at 40° C.; the lower the viscosity, the better is the mineral oil for use in the present invention. Kinetic viscosity measurement was used because of the low viscosity of the white mineral oil. The white mineral oil should have generally a kinetic viscosity (at 40° C.) lower limit of about 2 mm² sec⁻¹ (2 centistokes (cSt)); preferably 5 cSt, and more preferably 7.5 cSt. Generally, the upper limit Kinetic viscosity at 40° C. of the white mineral oil should be about 17 cSt. The white mineral oil also should have no aromatic content. It should be noted that any aromatic content of 100 ppm or less is considered to be free of aromatics. However, it is preferred that the aromatic content be less than 50 ppm, more preferably less than 30 ppm with zero aromatic content being the most desired level.

The light mineral oil content is present in the lower limit amount of 0.1% to an upper limit amount of 2.0% with the lower limit amount of 0.2% to an upper limit amount of 1.0% being preferred. The preferred commercially available white mineral oils are Carnation® oil from Witco, Marcol® 52 from Exxon, Ondina® 3 from Shell and Ecolane® 130 from TOTAL-FINA. With regard to the above mentioned requirements of the white mineral oil, the Ecolane® 130 product is the most suitable. It is considered to be free of aromatics (any content below 100 pm is considered as tracer), biodegradable, non-toxic, and classified in category “D” under Revised OCNS.

In addition to the light mineral oil performing the key function of enabling the effective use of fine particle size water-soluble polymer which might otherwise film-block and be ineffective due to fine particle size WSP's greater surface area and resulting speed of initial fluid takeup, the mineral oil also serves to dampen residual fines dust to a considerable degree and still allow for excellent free flow properties of the litter.

Light mineral oil can function as a non-toxic enrobing additive, which allows the use of fine powder water-soluble polymers while controlling dust. Light mineral oil also controls the fluid take-up speed thereby preventing film blocking that would otherwise compel the use of coarser, slower, less efficient particle size distribution, fluid retention/clumping additives. Light mineral oil acts to eliminate or dramatically reduce the dusting tendency of both the residual fines in a coarse calcium carbonate and the fine powder cellulose derivatives and other WSPs that can be used in this invention. Light mineral oil allows for the use of a cost-effective dose of cellulose derivatives and other WSPs due to its ability to permit discrete fine particles to individually take up fluid, not form a film or lumps and prevent the highly effective use of fine powder WSPs. Light mineral oil also retards the segregation or stratification of particles, which can occur in shipping of different size and density particles of an animal litter based on coarse calcium carbonate and fine particle clumping additives of this invention.

In accordance with the present invention, it should be understood that other oils or enrobing fluids can be used in this invention besides mineral oils, such as fragrance oils, sorbitol, glycerin, polyethylene glycol and mixtures thereof. In other words, any oil that is light, environmentally friendly, biodegradable, and edible can be used in the invention. It should be understood that the enrobing fluid does not completely cover the entire surface areas of all of the calcium carbonate particles but just a portion of the surfaces, because such a small amount of mineral oil cannot possibly coat the entire surface areas of all of the calcium carbonate in the litter. There simply is not enough mineral oil to cover all of the particles. Furthermore, only partial coating is needed to allow the water-soluble polymers to be uniformly distributed in the mixture and to tie up any residual fines of the calcium carbonate that may, or may not, be present.

In accordance to the present invention, the particulate, free-flowing but clumpable animal litter is prepared by a simple method. An appropriate quantity of coarse calcium carbonate is introduced into a mixing device such as an inclined rotating cylindrical container or v-type blender. In the method using an enrobing agent such as mineral oil, with the mixing device rotating, the required amount of light mineral oil is immediately added to the calcium carbonate in the mixing device. This addition of the mineral oil to the mixing device can be accomplished by several different methods. For example, the mineral oil can either be sprayed as a fine mist onto the particles or be aspirated into the mixer over an approximate 5 to 30 second period of time. A preferred size of calcium carbonate would be in the range of approximately 4 to 60 mesh, U.S. sieve series. A preferred type would be crushed marble as opposed to limestone.

Blending is allowed to continue for approximately 5 minutes during which time the mineral oil is uniformly dispersed to a sufficient degree. While still blending the required amount of fluid retention/clumping agent is then introduced by dusting it into the rotating blender and allowing an additional period of time of approximately 1 to 10 minutes, depending on the blending speed and efficiency, until the agent is uniformly dispersed. The clumping agent is present in a lower limit amount of 0.5% to an upper limit amount of approximately 4.0% based on the weight of the calcium carbonate with a lower limit of 1.0% to an upper limit of 1.5% being preferred.

The resulting treated coarse calcium carbonate litter will exhibit excellent fluid retention and clumping properties in response to an aliquot of water, pH-adjusted water or urine with the speed of fluid imbibition and resulting clump dimensions dependent on the choice of water soluble polymer and addition rate of mineral oil. In addition to excellent green strength in a wet phase which allows for removal within 60 seconds the clump also eventually will dry to a condition exhibiting excellent dry strength such that minimal breakage and contamination of unused litter occurs when the clump is removed and discarded.

In a method not using an enrobing agent, the calcium carbonate particles are simply mixed with an appropriate dose of the fluid-retention and clumping agent for a sufficient time to uniformly disperse the particles.

The following examples will serve to provide specific illustrations of the practice of this invention but they are not intended in any way to limit the scope of this invention. All parts and percentages are by weight unless otherwise denoted.

### EXAMPLES

Standard Procedure

The particulate, free flowing but clumpable, animal litter composition that was evaluated in the following Examples were prepared as follows: A coarse calcium carbonate or crushed marble litter was prepared according to the following bench-scale technique. In all of the Examples, the particle sizes of the calcium carbonate were in the range of from 4 to 12 mesh, based on US Standard Sieves. The bench technique used in the majority of development work included adding approximately 250 to 500 grams of particulate calcium carbonate to a large enough plastic container such that as much void space remained as the volume occupied by the calcium carbonate. To this container the required dose of light mineral oil was then added with the use of an eye dropper into the center of the calcium carbonate as opposed to along the walls of the container. A lid was then secured to the container and the sealed container was then vigorously agitated by hand to imitate as by shaking or tumbling by a machine for approximately 30 to 60 seconds in order to adequately coat the calcium carbonate. At the end of this short mixing period the appropriate dose of fluid retention and clumping agent was then added onto the top of the calcium carbonate with the lid then being replaced. After securing the lid the container was again agitated or shaken for approximately 30 to 60 seconds by hand until a sufficiently homogeneous mixture was obtained. Upon completion of this mixing technique lab portions of litter were then tested by placing about 250 grams of the composition in adequate sized disposable open tray lab dishes, i.e., a container size of 4″×4″×2″, with this container filled to a minimum depth of about 1 inch. Aliquots of 10 to 25 ml of water were then added to the compositions in the lab dishes and clump characteristics were then observed.

The ability to absorb the liquid before it reached the bottom of an approximate 1 inch layer of litter was measured as well as the green strength that the clump developed at the end of 60 seconds. Clumps were subsequently allowed to dry for 1-7 days and again were observed for their dry strength properties. Dusting was observed when the composition was poured from the mixing container to the open tray lab dishes.

### Example 1

Using the Standard Procedure, the following composition was prepared and evaluated.

| | Wt. Basis % |
|---|---|
| Coarse Calcium Carbonate | 98.8% |
| Mineral oil | 0.2% |
| Methylcellulose* | 0.7% |
| Methylhydroxyethylcellulose** | 0.3% |

*Specific type used was Culminal ® MC7000PF
**Specific type used was Culminal ® MHEC 25000PFF

### Example 2

A second Example utilizing guar gum as a partial fluid retention/clumping agent in a coarse calcium carbonate litter was prepared using the Standard Procedure. The composition had the following components:

| | Wt. Basis % |
|---|---|
| Coarse Calcium Carbonate | 98.4% |
| Mineral oil | 0.2% |
| Guar gum\hat{ } | 0.84% |
| Methylcellulose* | 0.56% |

*Specific type used was Culminal ® MC7000PF
\hat{ }Specific type used was Galactasol ® 20H51

### Example 3

This Example illustrates a composition made by the Standard Procedure which utilizes a combination of 3 different water soluble polymers.

| | Wt. Basis % |
|---|---|
| Coarse Calcium Carbonate | 97.8% |
| Mineral oil | 1.0% |
| Guar gum\hat{ } | 0.24% |
| Methylcellulose* | 0.68% |
| Methylhydroxyethylcellulose** | 0.28% |

### Example 4

This Example illustrates a composition made by the Standard Procedure which utilizes only one water soluble polymer.

| | Wt. Basis % |
|---|---|
| Coarse Calcium Carbonate | 98.8% |
| Mineral oil | 0.2% |
| Methylcellulose* | 1.0% |

*Specific type used was Culminal ® MC7000PF

COMPARATIVE TABLE

| | Control¹ | Ex. 1 | Ex. 2 | Ex. 3 | Ex. 4 |
|---|---|---|---|---|---|
| Speed of fluid take-up | 5-10 seconds | 5-10 seconds | 5-12 seconds | 5-12 seconds | 5-10 seconds |
| (clumpability) | | | | | |
| Green strength of clump | Very good | Excellent | Very good | Very good | Excellent |
| Dry strength of clump | Very good | Excellent | Excellent | Excellent | Excellent |
| Dustability | Low-Moderate | None | None | None | None |

¹The control was Tidy Cat Scoop ® multiple cat formula, marketed by Purina Co.

While this invention has been described with respect to specific embodiments, it should be understood that these embodiments are not intended to be limiting and that many variations and modifications are possible without departing from the scope and spirit of this invention.

What is claimed:

1. A particulate, free flowing but clumpable animal litter composition comprising discrete, non-swelling, non-absorptive, calcium carbonate particles and a fluid retention and clumping agent of at least one water-soluble polysaccharide.

2. The composition of claim 1, wherein the calcium carbonate particles are derived from crushed marble.

3. The composition of claim 1, wherein the calcium carbonate particles are present with a lower limit amount of 50 wt % based on the total weight of the composition.

4. The composition of claim 1, wherein the calcium carbonate particles are present with a lower limit amount of 70 wt % based on the total weight of the composition.

5. The composition of claim 1, wherein the calcium carbonate particles are present with an upper limit amount of 99 wt % based on the total weight of the composition.

6. The composition of claim 1, wherein the calcium carbonate particles are present with an upper limit amount of 95 wt % based on the total weight of the composition.

7. The composition of claim 1, wherein the calcium carbonate particles have particle sizes in the range of about 4 to 60 mesh, based on U.S. sieve series.

8. The composition of claim 1, wherein a nontoxic, biodegradable enrobing agent is further present.

9. The composition of claim 8, wherein the enrobing agent is selected from the group consisting of light mineral oil, sorbitol, glycerin, polyethylene glycol, and mixtures thereof.

10. The composition of claim 8, wherein the enrobing agent is light mineral oil.

11. The composition of claim 8, wherein the lower limit amount of the nontoxic, biodegradable enrobing agent is 0.1 wt %.

12. The composition of claim 8, wherein the lower limit amount of the nontoxic, biodegradable enrobing agent is 0.2 wt %.

13. The composition of claim 8, wherein the upper limit amount of the nontoxic, biodegradable enrobing agent is 2.0 wt %.

14. The composition of claim 8, wherein the upper limit amount of the nontoxic, biodegradable enrobing agent is 1.0 wt %.

15. The composition of claim 1, wherein the water-soluble polysaccharide is selected from the group consisting of methylcellulose (MC), MC derivatives, guar gum, guar gum derivatives, and mixtures thereof.

16. The composition of claim 15, wherein the MC derivatives are selected from the group consisting of methylhydroxyethylcellulose (MHEC) and methylhydroxypropylcellulose (MHPC).

17. The composition of claim 15, wherein a secondary polysaccharide is further present selected from the group consisting of carboxymethylcellulose (CMC), hydroxyethylcellulose (HEC), ethylhydroxyethylcellulose (EHEC), hydroxypropylcellulose (HPC), carrageenan, xanthan gum, alginate, and mixtures thereof.

18. The composition of claim 1, wherein the water-soluble polysaccharide is present in a lower limit amount of 0.5 wt %.

19. The composition of claim 1, wherein the water-soluble polysaccharide is present in a lower limit amount of 1.0 wt %.

20. The composition of claim 1, wherein the water-soluble polysaccharide is present in an upper limit amount of 4.0 wt %.

21. The composition of claim 1, wherein the water-soluble polysaccharide is present in an upper limit amount of 1.5 wt %.

22. The composition of claim 1, wherein the composition further comprises 10 to 20 wt % of a light weight filler.

23. The composition of claim 22 wherein the light weight filler is selected from the group consisting of pelletized corn cob biomass, rice hulls, peanut hulls, alfalfa, cedar sawdust, and mixtures thereof.

24. A method for preparing a free flowing particulate animal litter composition that clumps upon contact with an aqueous liquid comprising
a). providing coarse, non-swelling, non-absorptive calcium carbonate particles,
b) adding a sufficient amount of a water retention and clumping agent of at least one water-soluble polysaccharide to the calcium carbonate particles to form a mixture, and
c) blending the mixture to the desired uniformity to form the composition.

25. The method of claim 24, wherein the calcium carbonate particles are derived from crushed marble.

26. The method of claim 24, wherein the calcium carbonate particles are present with a lower limit amount of 50 wt % based on the total weight of the composition.

27. The method of claim 24, wherein the calcium carbonate particles are present with a lower limit amount of 70 wt % based on the total weight of the composition.

28. The method of claim 24, wherein the calcium carbonate particles are present with an upper limit amount of 99 wt % based on the total weight of the composition.

29. The method of claim 24, wherein the calcium carbonate particles are present with an upper limit amount of 95 wt % based on the total weight of the composition.

30. The method of claim 24, wherein the calcium carbonate particles have particle sizes in the range of about 4 to 60 mesh, based on U.S. sieve series.

31. The method of claim 24, further comprising distributing substantially uniformly a sufficient amount of a nontoxic, biodegradable enrobing agent over the calcium carbonate particles.

32. The method of claim 31, wherein the water-retention and clumping agent and enrobing agent is first made into a suspension and then distributed substantially uniformly over the calcium carbonate particles.

33. The method of claim 31, wherein the enrobing agent is first distributed over the calcium carbonate particles before the water-retention and clumping agent is added to the calcium carbonate particles.

34. The method of claim 31, wherein the nontoxic, biodegradable enrobing agent is selected from the group consisting of light mineral oil, sorbitol, glycerin, polyethylene glycol, and mixtures thereof.

35. The method of claim 34, wherein the enrobing agent is light mineral oil.

36. The method of claim 24, wherein the water-retention and clumping agent is selected from the group consisting of methylcellulose (MC), MC derivatives, guar gum, guar gum derivatives, and mixtures thereof.

37. The method of claim 36, wherein the MC derivatives are selected from the group consisting of methylhydroxyethylcellulose (MHEC) methylhydroxypropylcellulose (MHPC), and mixtures thereof.

38. The method of claim 36, wherein a secondary polysaccharide is further present selected from the group consisting of carboxymethylcellulose (CMC), hydroxyethylcellulose (HEC), ethylhydroxyethylcellulose (EHEC), hydroxypropylcellulose (HPC), carrageenan, xanthan gum, alginate, and mixtures thereof.

39. The method of claim 24, wherein the sufficient amount of the water retention and clumping agent has a lower limit of 0.5 wt %.

40. The method of claim 24. wherein the sufficient amount of the water retention and clumping agent has a lower limit of 1.0 wt %.

41. The method of claim 24, wherein the sufficient amount of the water retention and clumping agent has an upper limit of 4.0 wt %.

42. The method of claim 24, wherein the sufficient amount of the water retention and clumping agent has an upper limit of 1.5 wt %.

43. The method of claim 31, wherein the sufficient amount of the enrobing agent has a lower limit of 0.1 wt %.

44. The method of claim 31, wherein the sufficient amount of the enrobing agent has a lower limit of 0.2 wt %.

45. The method of claim 31. wherein the sufficient amount of the enrobing agent has an upper limit of 2.0 wt %.

46. The method of claim 31. wherein the sufficient amount of the enrobing agent has an upper limit of 1.0 wt %.

47. The method of claim 24, wherein the composition further comprises 10 to 20 wt % of a light weight filler.

48. The method of claim 47, wherein the light weight filler is selected from the group consisting of pelletized corn cob biomass, rice hulls, peanut hulls, alfalfa, cedar sawdust, and mixtures thereof.
